(19) United States
(12) Patent Application Publication
(10) Pub. No.: US 2005/0150354 A1
(43) Pub. Date: Jul. 14, 2005

(54) Hold down clamp

(76) Inventors: Michael Paul, New Britain, CT (US); Robert Gatzan, Newington, CT (US)

Correspondence Address: Mr. William W. Haefliger, Suite 512, 201 S. Lake Ave., Pasadena, CA, 91101, US

(21) Appl. No.: 10/755,912

(22) Filed: Jan. 13, 2004

(51) Int. Cl. G10D 13/02

(52) U.S. Cl. 84/422.1

(57) ABSTRACT

A base drum rim clamp device comprising in combination, a base, a wedging device to exert clamping force that device carried by the base, means to displace said device to move a surface or surfaces of the device relatively toward one side of a base drum rim, and a clamp part to which clamping force is transmitted at the opposite side of the drum rim.

### BACKGROUND OF THE INVENTION

This invention relates generally to clamping of drum rims, and more particularly to an improved, easily adjustable, clamping device, positively connectible to a drum rim so as not to inadvertently loosen or disconnect.

There is need for improvements in drum associated clamping devices of rugged construction, to provide the advantages as referred to, as well as other advantages, as will be seen.

### SUMMARY OF THE INVENTION

It is a major object of the invention to provide an improved drum rim clamping apparatus, as may be incorporated on a pedal unit that drives a drum beater. Basically, the invention is embodied in a combination that includes:
a) a base
b) a wedging device to exert clamping force, that device carried by the base,
c) means to displace said device to move a surface or surfaces of the device relatively toward one side of a base drum rim, and
d) a clamp part to which clamping force is transmitted at the opposite side of the drum rim.

As will be seen, that device may advantageously include two wedges carried for adjustable relative movement toward one another, or away from one another. The wedges easily support drum rims of different curvature, as at spaced surface locations on the wedges. The wedges typically have substantially flat surfaces that extend in tangential contact relation with the arcuate rim, for stable support of the rim.

It is another object of the invention to provide for carriage of both wedges for simultaneous relative movement toward one another, or away from one another.

Such movement may be effected by a displacer having screw thread operative connection to the device. The displacer may advantageously comprise an adjustably rotatable displacer having screw thread operative connection to the wedges. In this regard, the displacer may have differential screw thread operative connection to the wedges, whereby, as the displacer is rotated in one rotary direction the wedges are relatively displaced toward one another, and as the displacer is rotated in the opposite rotary direction, the wedges are relatively displaced away from one another. Also, the wedges may have aligned bores which are threaded to receive differential threading on the displacer, whereby both wedges are moved, to clamp the drum rim in response to simple rotation of the displacer in one direction, and with mechanical advantage. The threaded bores and the displacer threading define worm gearing, which prevents unclamping of the rim during drum beating.

A further object is to provide a guide channel on the base, extending in generally perpendicular relation to a base plate of a pedal unit carrying the channel, that unit including a pedal pivotally carried by the base plate, a drum beater pivotally carried by the base plate, and a drive connected between the pedal and the drum beater. The clamp unit of the invention is also useful in other environments, as will be seen.

These and other objects and advantages of the invention, as well as the details of an illustrative embodiment, will be more fully understood from the following specification and drawings, in which:

### DRAWING DESCRIPTION

Fig. is a side elevation of a pedal unit carrying base drum rim clamping structure;

FIG. 2 is a frontal elevation taken on lines 2-2 of FIG. 1;

FIG. 3 is a top plan view taken on lines 3-3 of FIG. 1;

FIG. 4 is an enlarged fragmentary end view taken on lines 4-4 of FIG. 3;

FIG. 5 is an enlarged frontal view taken on lines 5-5 of FIG. 3;

FIG. 6 is a top plan view taken on lines 6-6 of FIG. 5;

FIG. 7 is a frontal view of a modification, in which the wedge clamping device is employed between a drum hoop and structure including a support rod and an auxiliary clamp; and

FIG. 8 is an elevation taken on lines 8-8 of FIG. 7.

### DETAILED DESCRIPTION

In FIG. 1, a pedal 10 is pivoted at 11 to a heel support 12, attached to base plate 13. A flexible coupling, such as a chain 14 is connected at 15 to the forward end of the pedal 10, and extends upwardly at 14a to mesh with and/or wrap on a sprocket or drum 16. The latter is fixedly mounted to an axle 17, whereby, as the pedal is pushed down by the user's shoe or foot, the sprocket and axle are rotated; the beater 19 then rotates forwardly so that head 20 strikes the bass drum surface or head indicated at 21.

Yieldable means, such as tension spring 22 is operatively connected between a rotor 23 on the axle, and the frame, such as the lower end of pedestal 24, to yieldably resist axle rotation, and return the beater to FIG. 1 position. Rotor 23 defines an effective crank arm 23a to which a spring support 25 is connected. A spring tension adjustment means is shown at 27. Two pedestals 24 and 24a support the axle 17, for rotation, and are carried by the base plate 13.

In accordance with an important aspect of the invention, a clamp device, for attachment to a base drum rim 30, is indicated generally at 31. That device preferably includes:
a) a base 32,
b) a wedging device, such as two wedges 33 and 34 to exert clamping force, the device or wedges carried by the base,
c) means to displace that device to move a device surface or surfaces relatively toward one side of base drum rim 30, and
d) a clamp part 37a to which clamping force is transmitted at the opposite side of the drum rim.

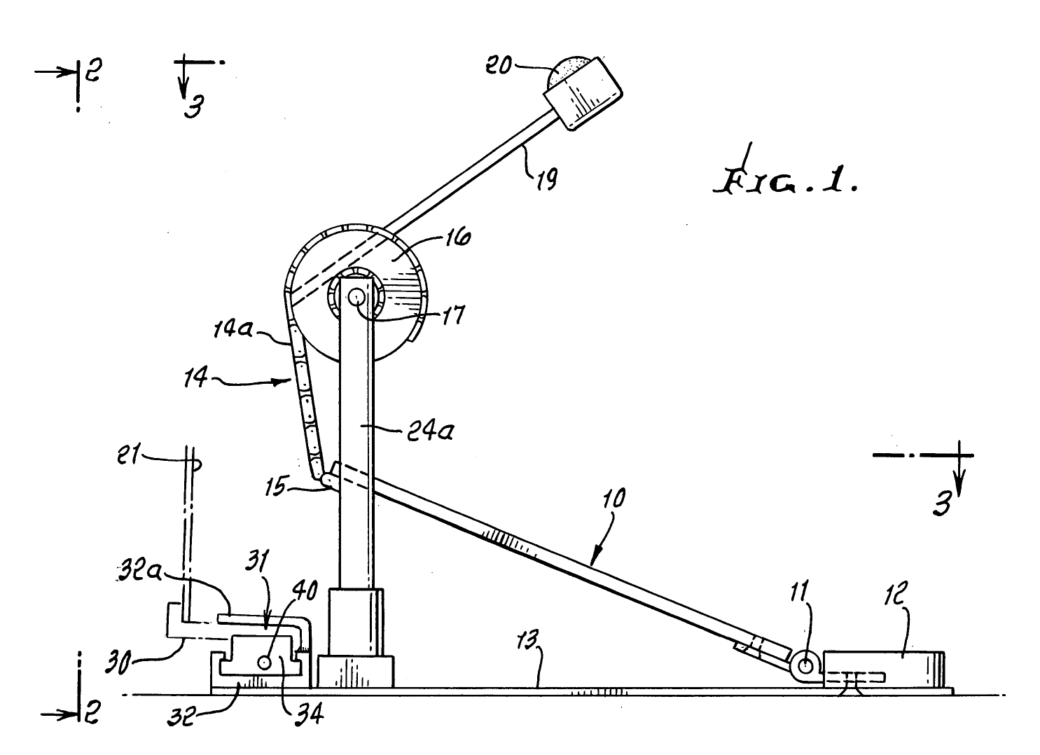

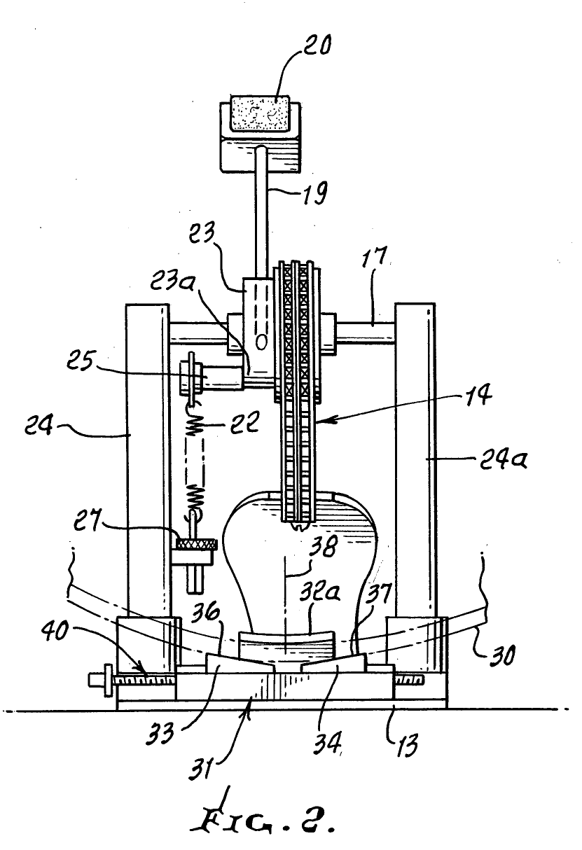

The two wedges are carried for adjustable relative movement, of at least one wedge and preferably both wedges, toward one another, or away from one another. Typically, the two wedges are slidably carried by the base 32 for simultaneous relative movement toward one another, or away from one another. In this regard, the drum rim, which may be metallic, is arcuate, for example circular, and stably supported on wedge oppositely angled surfaces, at spaced contact locations. For example such locations 36 and 37 are at approximately equal spacings from a vertical plane 38 normal to the plane of FIG. 2. The wedges are also typically metallic, and their angled surfaces are flat and extend in tangential contact with the outer side of the drum rim, which they support, enabling sliding of the wedges under the rim.

Means is provided to displace the device 31 to move a surface or surfaces of the device relatively toward one side (typically the outer side) of the drum rim; and a clamp part is provided to which clamping force exerted by device 31 is transmitted, via the rim, at the opposite side of the rim. As shown, such means may take the form of a displacer 40 having screw thread operative connection to device 31, as for example to the wedges 33 and 34. The illustrated displacer 40 extends lengthwise transversely through aligned bores 41 in the two wedges and has screw thread 40a operative connected to that threading at such bores. That threading connection is differential as respects the two wedges, as for example in turnbuckle relation, whereby, as the displacer is rotated in one rotary direction the wedges are relatively displaced toward one another, to tighten the wedge connections to the drum rim, and as the displacer is rotated in the opposite rotary direction, the wedges are relatively displaced away from one another, to loosen that connection.

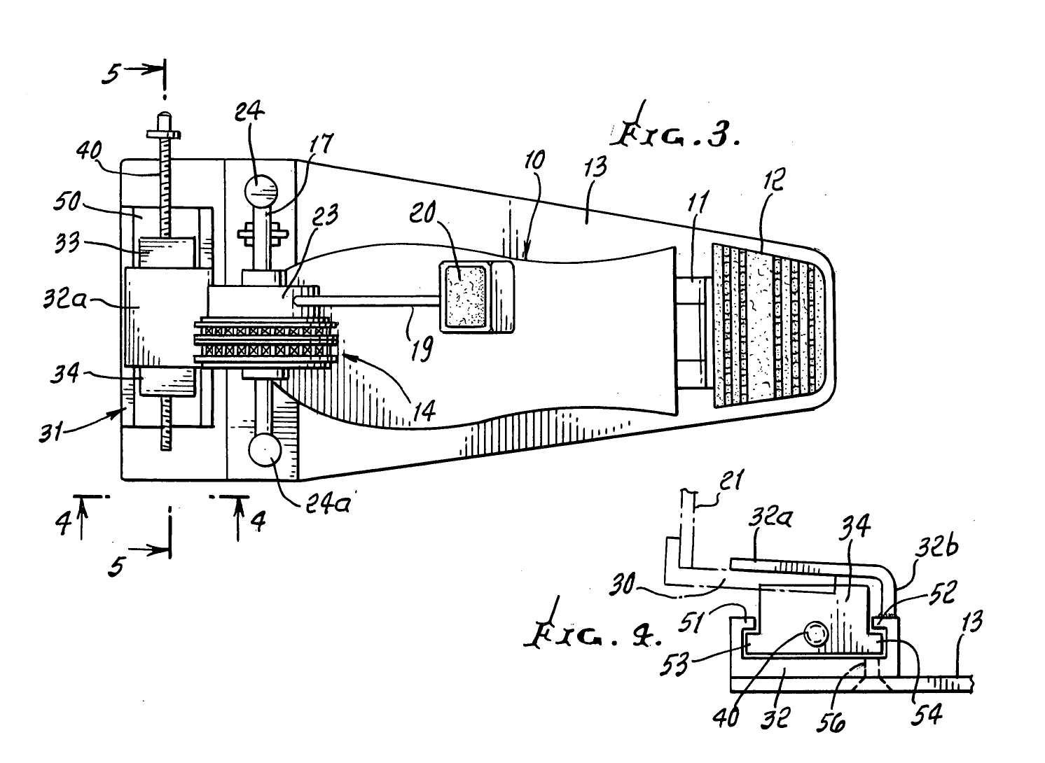

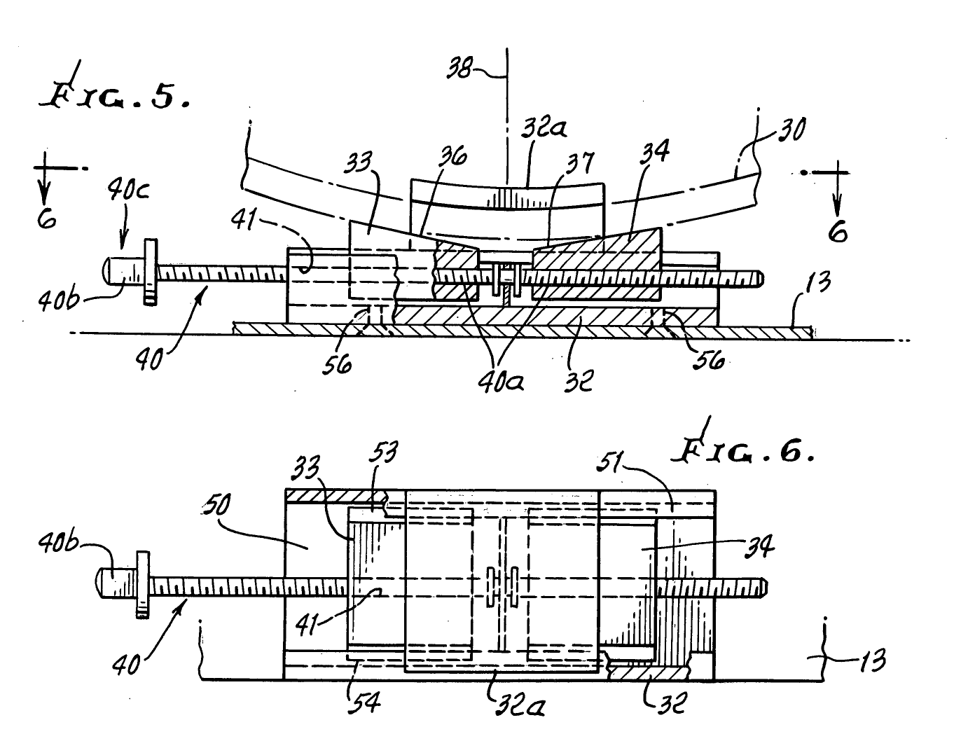

Accordingly, as the elongated displacer is rotated in one direction, the drum rim is clamped between the wedges and fixed part 32a, and with high mechanical advantage, such as to prevent undesired unclamping of the clamped rim during drum beating impacts, transmitted to the device 10. Part 32a is shown in the form of a tongue extending upwardly at 32b from the base, and projecting at 32a over the drum rim inner side. See FIG. 1. The end 40a of the displacer may have wrench flats 40b enabling clamping rotary tightening of the displacer by one of a wrench. Wedges 33 and 34 may slide or travel in a channel 50 defined by the base 32. See in FIG. 4, for example channel lips 51 and 52 in FIG. 4, over hanging wedge sideward extensions 53 and 54. A T-slot arrangement is thereby defined.

Base 32 may be attached, as by fasteners 56, to the plate 13 of the drum beater device, for supply at the time of manufacture and sale of the drum beater device; or the clamp device 31 may be separately produced and sold, and it may have other clamping uses, as enabled by fastener attachment to other devices.

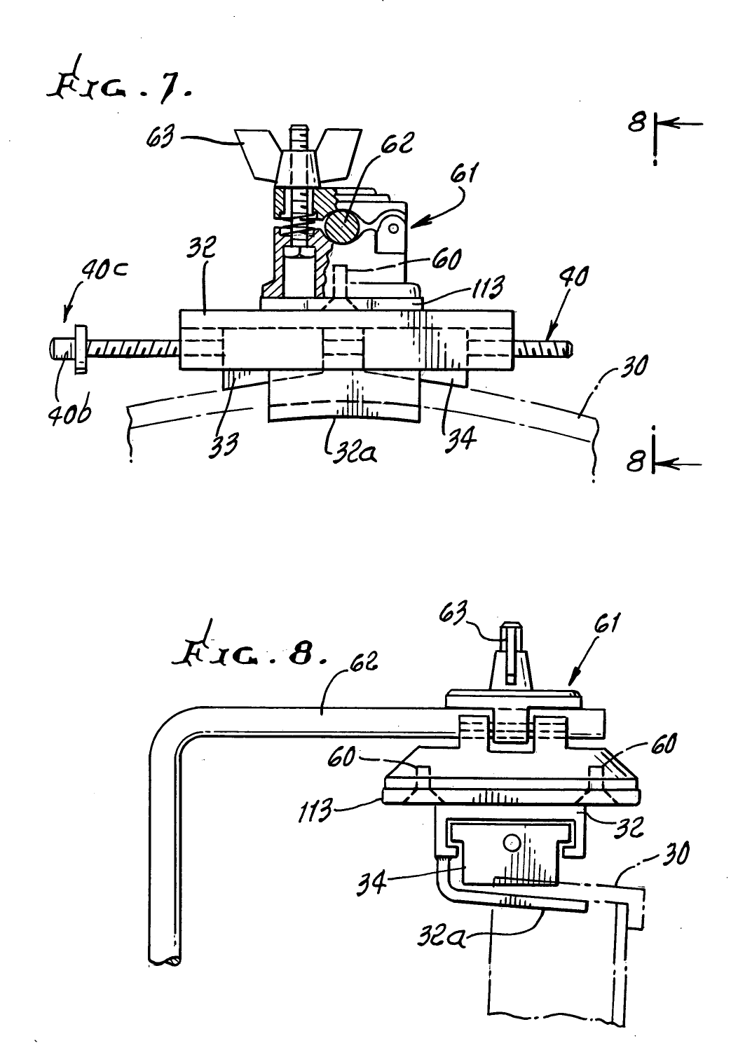

FIGS. 7 and 8 show fastener 60 attachment of base 32 and plate 113 to an auxiliary clamp structure 61 attached to a rod 62. When wing nut 63 is loosened, clamp structure 61 is loosened and may be adjustably shifted along the rod. The wedges 33 and 34 are shown clamped to a drum rim 30, as before.

Additional advantage include:
The single point hold-down method distorts the bass drum hoop under tension. This distributes uneven amount of pressure applied to the drumhead. Therefore, evenness in tuning is not achieved, resulting in the reduction of vibration (resonance) and degradation of fundamental pitch development of the bass drum sound. Conversely, the 3-point/prism clamp establishes equal contact with minimal pressure placed along the bass drum hoop. The technique alleviates inherent problems in the single point clamping technique allowing accurate tuning of the bass drumhead.
Finally, the 3-point clamping technique offers positive contact between the pedal and the hoop, insuring the pedal or percussion instrument from loosening up due to the extreme forces of rigorous performance.

1. A base drum rim clamp device comprising in combination.
a) a base,
b) a wedging device to exert clamping force, that device carried by the base,
c) means to displace said device to move a surface or surfaces of the device relatively toward one side of a base drum rim, and
d) a clamp part to which clamping force is transmitted at the opposite side of the drum rim.

2. The combination of claim 1 wherein said device comprises two wedges carried for adjustable relative movement toward one another, or away from one another.

3. The combination of claim 2 wherein the base has structure that guides such relative movement.

4. The combination of claim 2 including the drum rim which is arcuate, and is supported on the wedges, at spaced locations.

5. The combination of claim 2 wherein both wedges are slidably carried for simultaneous relative movement toward one another, or away from one another.

6. The combination of claim 3 wherein said structure defines a channel, along which both wedges are movable.

7. The combination of claim 4 wherein the wedges have substantially flat surfaces that extend in tangential contact relative with the arcuate rim.

8. The combination of claim 1 wherein said means to displace the device includes a displacer having screw thread operative connection to the device.

9. The combination of claim 2 wherein said means to displace the device includes an adjustably rotatable displacer having screw thread operative connection to the wedges.

10. The combination of claim 9 wherein the displacer has differential screw thread operative connection to the wedges, whereby, as the displacer is rotated in one rotary direction the wedges are relatively displaced toward one another, and as the displacer is rotated in the opposite rotary direction, the wedges are relatively displaced away from one another.

11. The combination of claim 10 wherein the wedges have aligned bores which are threaded to receive differential threading on the displacer, whereby both wedges are moved, to clamp the drum rim in response to simple rotation of the displacer in one direction, and with mechanical advantage.

12. The combination of claim 11 wherein the threaded bores and said displacer threading define worm gearing, which prevents unclamping of the rim during drum beating.

13. The combination of claim 1 including a pedal unit having a base plate supporting said base, a pedal pivotally carried by the base plate, a drum beater pivotally carried by the base plate, and a drive connected between the pedal and the drum beater.

14. A clamping device comprising in combination
a) a base,
b) a wedging device to exert clamping force, that device carried by the base,
c) means to displace said device to move a surface or surfaces of the device relatively toward one side of an object to be clamped, said device including two wedges to be relatively moved toward or away from one another,
d) a clamp part to which clamping force is transmitted to the opposite side of the object.

15. The combination of claim 14 including an auxiliary clamp associated with the base to attach the base to a second object.

16. The combination of claim 15 including said second object which comprises a mounting rod.

17. The combination of claim 14 wherein said means to displace the device includes an adjustably rotatable displacer having screw thread operative connection to the wedges.
